(19) United States
(12) Patent Application Publication
(10) Pub. No.: US 2015/0235225 A1
(43) Pub. Date: Aug. 20, 2015

(54) Security System and Method for a Payment Card

(71) Applicant: Rebecca Christie, Sanborn, NY (US)

(72) Inventor: Rebecca Christie, Sanborn, NY (US)

(21) Appl. No.: 14/183,941

(22) Filed: Feb. 19, 2014

(51) Int. Cl. G06Q 20/40; G06Q 20/34; G06K 19/16

(52) U.S. Cl. CPC G06Q 20/40145; G06K 19/16; G06Q 20/4012; G06Q 20/355

(57) ABSTRACT

A security system and method for a payment card to protect against card fraud and identity theft through eclectic security features that create a synergy for verifying a card holder identity and unique card holder information. The security features can be integrated into the payment card or function remotely from the payment card, triggered upon usage of the payment card. The payment card has minimal information embossed thereon. The card number is in the form of a hidden card number, known only to the card holder, and correlating to a card number code. The card number code provides information about the payment card and card holder, indirectly linking to account information. A holographic face image and fingerprint image display on the card for further card holder identification. A personal identification number, selected and changeable by the card holder is required to enable a transaction.

### BACKGROUND OF THE INVENTION

1. Field of the Invention

This invention relates to a security system and method for a payment card, and more particularly relates to a security system and method that incorporates eclectic security features onto a payment card, such as hidden numbers, codes, holographic images, and card holder verification to help prevent card fraud and identity theft.

2. Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often, a payment card is a card that can be used by a cardholder and accepted by a merchant to make a payment for a purchase, or in payment of some other obligation. One type of payment card is a credit card. The credit card is issued to users as a system of payment. It allows the cardholder to pay for goods and services based on the card holder's promise to pay for them. The card issuer creates a revolving account and grants a line of credit to the card holder from which the card holder can borrow money for payment to a merchant or as a cash advance to the user.

It is known in the industry that payment card fraud costs commerce millions of dollars each year. For these reasons all payment card companies have launched various security features and card holder verification programs to help reduce the amount of fraud. The security features range from passwords, to pictures on the payment card, and predetermined spending limitations.

Often, the payment card uses numerous security features in conjunction to help protect against this fraud and theft. The payment card security features can depend on the physical security of the plastic card as well as the remotely accessible privacy of the card number. In this manner, when an unauthorized person has access to the card or its number, security features stand a chance of creating an alert, or deactivating the payment card.

In many instances, technology provides the option for card issuers to initiate controls on the payment card that can be turned on and off and varied by the card holder in real time as circumstances change. Additionally, there are security features present on the physical payment card itself in order to prevent counterfeiting. For example, most modern credit cards have a watermark that will fluoresce under ultraviolet light.

It is known that holography is a technique which enables three-dimensional images to be made. It involves the use of a laser, interference, diffraction, light intensity recording and suitable illumination of the recording. The image changes as the position and orientation of the viewing system changes in exactly the same way as if the object were still present, thus making the image appear three-dimensional. Holographic images are difficult to counterfeit.

In view of the foregoing, it is clear that these traditional techniques are not perfect and leave room for more optimal approaches.

From the foregoing discussion, it should be apparent that a need exists for a security system and method that incorporates a variety of novel security features in the card, such as, hidden card numbers, codes, holographic images, and card holder verification into a payment card for preventing card fraud and identity theft. These different security features may be used in together in any combination to form a synergy that protects a card holder and a card issuer from fraud and theft.

Accordingly, the present invention has been developed to provide a system and method for a card holder and a card issuer to protect against fraud and theft through a combination of security features that create a synergy for verifying a card holder identity and unique card holder information. The security features may be integrated into the payment card, and initiated by the card holder, the card issuer, or a merchant. However, in other embodiments, the security features may function remotely from the payment card, at a financial institution, server, or card issuer, whereby the security features are triggered upon usage of the payment card.

In some embodiments, the payment card may include, without limitation, a credit card, a debit card, an ATM card, a charge card, a gift certificate card, and a stored value card. The payment card may utilize both physically integrated and remote security features designed to at least partially prevent card theft and identity fraud. For example, the security system may electronically link the payment card to a card holder account, such as a remote data storage site or a financial institution.

In some embodiments, the security system may utilize a hidden card number with the payment card. The hidden card number may include a card number, and/or an expiration date, and/or a card verification number that remains hidden by not displaying on a front or back surface of the payment card. In this manner, the card number cannot be used by an unauthorized user. In some embodiments, the hidden card number may correlate to a card number code, known only to the cardholder. In some embodiments, the card number code may provide information about the payment card, including, without limitation, account information, address, and other verifying information. The card number code provides an indirect link to a remote data storage site for accessing the information. In this manner, the account of the card holder is better protected. In one embodiment, the card number code may be stored with the card issuer, or a remote data storage site. A point-of-sale card reader may read the card number code during a transaction, yet not have the capacity to read or display the hidden card number. In this manner, the merchant cannot view the hidden card number. In essence, visibly hiding the card number and allowing only an indirect link to the card holder information provides measurable security.

Those skilled in the art will recognize that by removing visible indications of the card number, unauthorized remote transactions may be restricted. For example, a phone purchase often requires a card number. In some embodiments, the, hidden card number may be scanned or read by a point-of-sale machine. However, the hidden card number may not be made visible or read by the point-of-sale card reader; but rather the correlating card number code displays for the merchant. The point-of-sale card reader may read the card number code, and not read or display the hidden card number. In this manner, not even the merchant can view the hidden card number, but rather, only the card holder would have access and knowledge to the card number. Though not visible, the hidden card number can still be verified through the point-of-sale card reader by swiping, scanning, verbally telling the merchant, or the card holder keying in the hidden card number during the transaction.

A second security feature may include a three dimensional holographic image, such as a holographic face or fingerprint image, which displays on the payment card. Those skilled in the art will recognize that holographic images are difficult to forge because they are replicated from a master hologram which requires expensive, specialized, and technologically advanced equipment. In one embodiment, a holographic face image of the card holder may print on a front side of the card to provide yet another layer of proof that the card holder is actually the authorized user. Additionally, a holographic fingerprint image of the card holder's fingerprint may be affixed to a back side of the payment card. The holographic fingerprint image may work in conjunction with a fingerprint reader. In some embodiments, the holographic fingerprint image may be used by the merchant, including large corporations, to access identification and account information about the card holder. From the holographic fingerprint image, the merchant may store card holder information directly rather than as alphanumeric codes. The holographic images may also be efficacious for eliminating the need for magnetic strips on the payment card.

An additional security feature employed by the system may include a personal identification number (PIN) that is unique to the card holder, and shared between the card holder and a remote financial processor or card issuer. The PIN may be used to authenticate the card holder to the merchant. The PIN does not have to be disclosed to the merchant by the card holder at any point during the transaction. The PIN can, however, be read by a point-of-sale card reader, through a swiping or scanning process. In some embodiments, the card holder may have the authority to alter the PIN at any time. In one embodiment, the PIN is embedded into the payment card as a magnetic code.

For additional security, the PIN can be changed periodically by the card holder. Furthermore, the point-of-sale card reader may automatically verify the PIN without requiring the card holder to enter the last four digits, as is commonly required. In another embodiment, the PIN may be read completely by the point-of-sale card reader through swiping or scanning. However, the card holder may also enter the PIN directly into the point-of-sale card reader.

In some embodiments, entry of the PIN into the point-of-sale card reader may provide verification that the payment card is actually in the hand of the merchant. The PIN may be automatically retrieved when a magnetic strip of a card is swiped on a point-of-sale card reader, and verified by a card issuer. However, should the payment card by forged, one limitation is that the PIN would still be valid.

Yet another security feature incorporated into the payment card is the capacity to perform a decoy swipe with a decoy magnetic strip on the payment card. The decoy swipe may enables a merchant or card holder to pass the decoy magnetic strip through a point-of-sale card reader to give the impression that the payment card utilizes a magnetic strip. The swiping motion may help create the impression the payment card can be swiped. For example, an unauthorized user may think the payment card is void if the decoy magnetic strip does not trigger a transaction. In some embodiments, an additional security feature may comprise the merchant processing the payment card to verify if sufficient funds are available for performing the transaction with the payment card. If funds are available, the transaction proceeds. Otherwise, the transaction is cancelled and an alert may be sent to the card holder and/or the card issuer. The hidden card number remains hidden from the merchant during this funds availability check, though.

In one embodiment, the system provides numerous security features prior to the transaction, such as when the payment card is initially received by the card holder. The card issuer may send the card holder the payment card, and distribute a PIN to the card holder, possibly through mail, email, text, or verbally in person. The holographic picture and fingerprint on the payment card may have been provided during the application process for the payment card. The initial transaction performed by the card holder may require entry of the PIN. The PIN may be keyed in by the card holder initially. In another early form of security, the card holder can set predetermined transaction parameters, such as spending limits, red flag alerts for certain transactions, and time usage parameters.

These security features may be combined on one payment card, and work in conjunction with a remote data storage site, such as a bank or a financial institute. However in other embodiments, multiple payment cards may be used various combinations to achieve the desired security.

A first aspect of a security system for preventing fraud and theft on a payment card, comprises:
a payment card configured to help prevent payment card theft and identity fraud, the payment card comprising a minimal amount of information visible thereon,
the payment card comprising a hidden card number configured to identify the payment card and the card holder, the hidden card number arranged to remain at least partially invisible on the payment card, the hidden card number further configured to correlate to a card number code, the card number code configured to be different than the hidden card number, the card number code configured to verify a unique information about the card holder and the payment card for performing the transaction, the card number code further configured to form an indirect link to the unique information about the card holder and the payment card,
wherein a merchant views the card number code rather than the hidden card number for performing the transaction,
the payment card further comprising a holographic face image configured to replicate a card holder face, the holographic face image configured to verify the card holder for performing the transaction,
the payment card further comprising a holographic fingerprint image configured to replicate a card holder fingerprint, the holographic fingerprint image and the card holder fingerprint configured to be scannable by a fingerprint reader for verifying the card holder and performing the transaction,
the payment card further comprising a personal identification number configured to verify the card holder to the merchant, the personal identification number configured to be provided for enabling the transaction, the personal identification number further configured to be changed by the card holder,
wherein, only the card holder and/or the card issuer know the personal identification number,
wherein the security system is configured to deny the transaction based on failed verification of the unique information about the card holder and the payment card through the card number code, and/or the holographic face image, and/or the holographic fingerprint image, and/or the personal identification number.

In a second aspect, the payment card comprises a credit card, a debit card, a charge card, or a gift certificate card.

In another aspect, the hidden card number comprises a card number and/or an expiration date, and/or a card verification number.

In another aspect, the hidden card number is configured to magnetically embed in the payment card and/or store in a remote data storage site.

In another aspect, the holographic face image is arranged on a front surface of the payment card.

In yet another aspect, the holographic fingerprint image is arranged on a back surface of the payment card.

In yet another aspect, the personal identification number is known only by the card holder and/or the card issuer.

In yet another aspect, the personal identification number is configured to magnetically embed in the payment card and/or store in a remote data storage site.

In yet another aspect, the point-of-sale reader and the fingerprint reader operatively connect to a remote data storage site, the remote data storage site comprising a unique information about the card holder and the payment card.

One objective of the present invention is to provide a plurality of security features that form a synergy on a single payment card.

Another objective is to provide a relatively inexpensive security system for a payment card.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a block diagram view of an exemplary security system for a payment card, in accordance with an embodiment of the present invention;

FIGS. 2A and 2B illustrate detailed perspective views of an exemplary fingerprint reader and an exemplary holographic fingerprint image, where FIG. 2A illustrates an exemplary fingerprint reader scanning fingerprints, and FIG. 2B illustrates an exemplary holographic fingerprint image, in accordance with an embodiment of the present invention;

FIG. 3 illustrates a detailed perspective view of an exemplary payment card swiping an exemplary point-of-sale reader, in accordance with an embodiment of the present invention;

FIG. 4 illustrates a flowchart diagram of an exemplary security method for a payment card; and

FIG. 5 illustrates a block diagram depicting an exemplary client/server system which may be used by an exemplary web-enabled/networked embodiment of the security system and method for a payment card, in accordance with an embodiment of the present invention.

Like reference numerals refer to like parts throughout the various views of the drawings.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

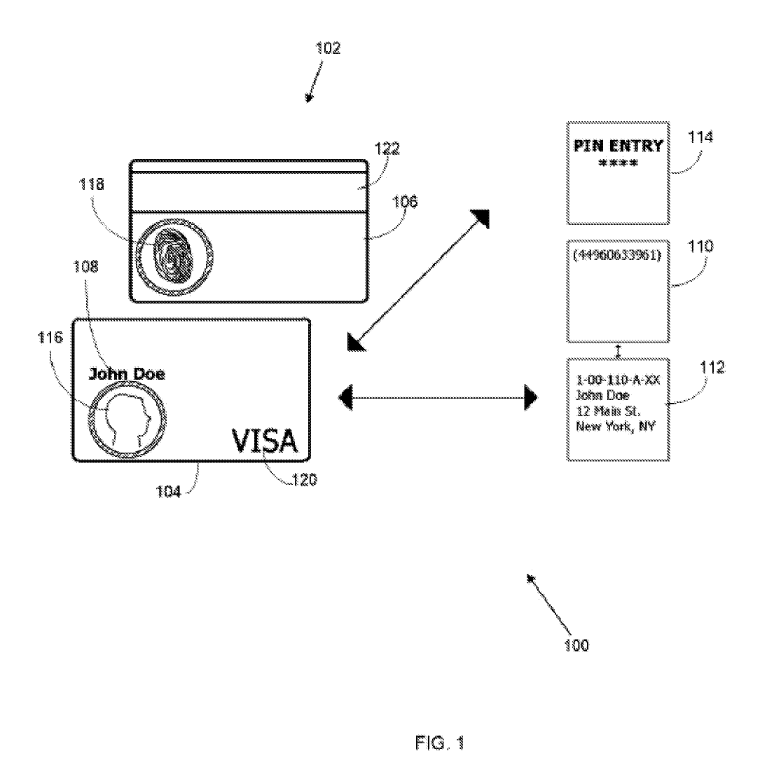

The present disclosure, as referenced in the block diagram of FIG. 1, is generally directed to a security system 100 for a payment card. The system 100 is efficacious for allowing a card holder 108 and a card issuer 120 to protect against fraud and theft through a combination of security features that create a security synergy, both physically on a payment card 102, and remotely on a remote data storage site (not shown). The security features help to verify a card holder identity and provide unique card holder information. The security features may be integrated into the payment card 102, and initiated by the card holder 108, the card issuer 120, or a merchant. However, in other embodiments, the security features may function remotely from the payment card 102, at a remote data storage site, such as, a financial institution, server, or card issuer 120. For example, the security system 100 may electronically link the payment card 102 to a card holder account or a financial institution. In this manner, the security features are triggered upon usage of the payment card 102.

In some embodiments, the payment card 102 may include, without limitation, a credit card, a debit card, an ATM card, a charge card, a gift certificate card, and a stored value card. The payment card 102 may be sized and dimensioned as a rectangular shape, having 3⅜″×2⅛″ dimensions. In some embodiments, the payment card 102 may conform to the ISO/IEC 7810ID-1 standard. The payment card 102 may also have embossed card issuer information, logos, and card holder information on both a front surface 104 and a back surface 106. The payment card 102 may utilize both physically integrated and remote security features designed to at least partially prevent card theft and identity fraud.

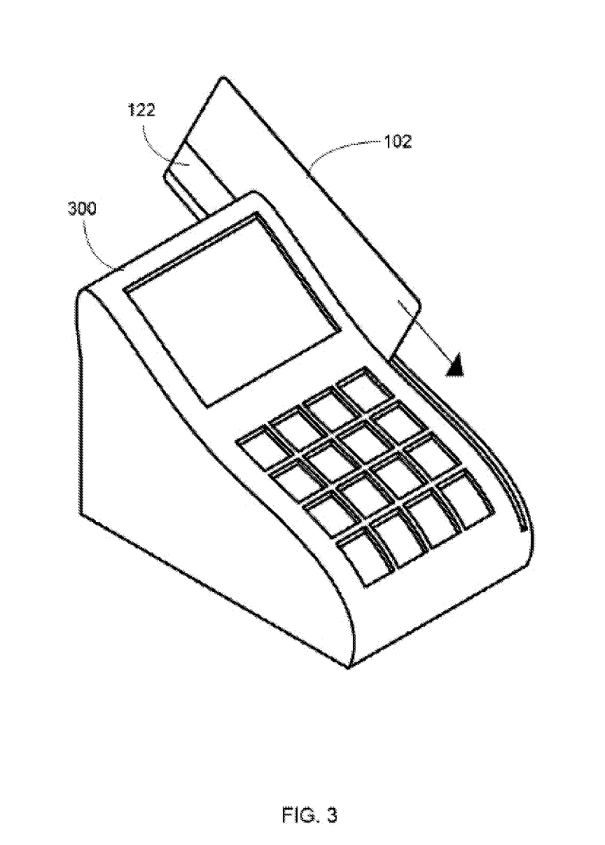

As referenced in FIG. 1, the security system 100 may utilize a hidden card number 110 with the payment card 102. The hidden card number 110 may include a card number, and/or an expiration date, and/or a card verification number that remains hidden by not displaying on a front or back surface 104, 106 of the payment card 102. In this manner, the card number cannot be used by an unauthorized user. In some embodiments, the hidden card number 110 may correlate to a card number code 112, known only to the card holder 108. In some embodiments, the card number code 112 may provide information about the payment card 102, including, without limitation, account information, address, and other verifying information. The card number code 112 provides an indirect link to a remote data storage site for accessing the information. In this manner, the account of the card holder 108 is better protected. The card number code 112 may be stored with the card issuer 120, or a remote data storage site. A point-of-sale card reader 300, referenced in FIG. 3, may read the card number code 112 during a transaction, yet not have the capacity to read or display the hidden card number 110. In this manner, the merchant cannot view the hidden card number 110. In essence, visibly hiding the card number and allowing only an indirect link to the card holder information provides measurable security.

Those skilled in the art will recognize that by removing visible indications of the card number, unauthorized remote transactions may be restricted. For example, without limitation, an online or telephone transaction may require a card number to finalize the deal. An unauthorized user would not have the capacity to provide the card number, and thereby the unauthorized transaction could not proceed. In some embodiments, the, hidden card number 110 may be scanned or read by a point-of-sale card reader 300. However, the hidden card number 110 may not be made visible or read by the point-of-sale card reader 300; but rather the correlating card number code 112 displays for the merchant. The point-of-sale card reader 300 may read the card number code 112, and not read or display the hidden card number 110. In this manner, not even the merchant can view the hidden card number 110, but rather, only the card holder 108 would have access and knowledge to the card number. Though not visible, the hidden card number 110 can still be verified through the point-of-sale card reader 300 by swiping, scanning, verbally telling the merchant, or the card holder 108 keying in the hidden card number 110 during the transaction.

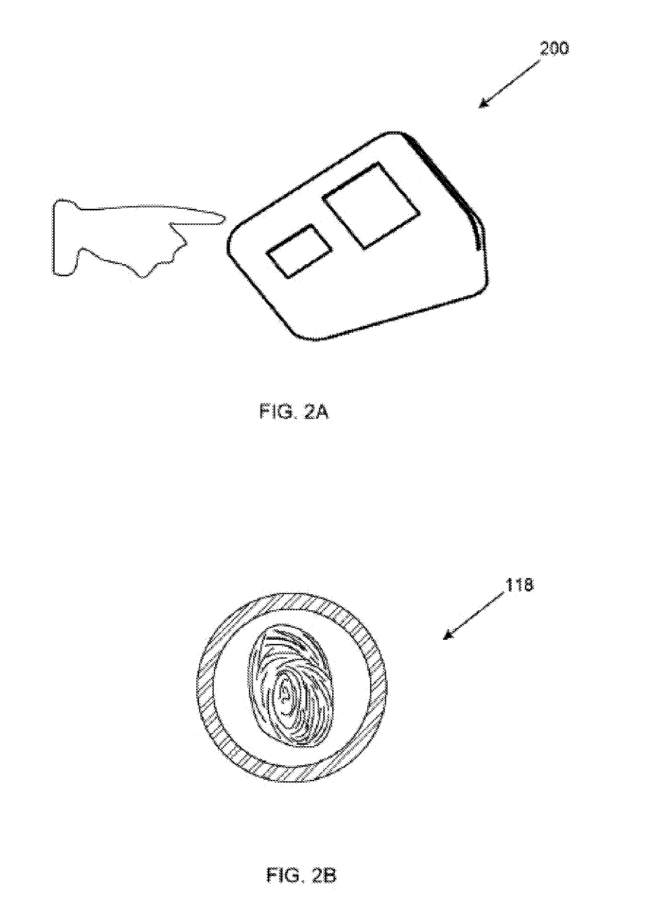

Turning now to FIGS. 2A and 2B, a second security feature may include a three dimensional holographic image, such as a holographic face or fingerprint image 118, which is displays on the payment card 102. Those skilled in the art will recognize that holographic images are difficult to forge because they are replicated from a master hologram which requires expensive, specialized, and technologically advanced equipment. In one embodiment, a holographic face image 116 of the card holder 108 may print on a front side of the card to provide yet another layer of proof that the card holder 108 is actually the authorized user. The picture of the card holder 108 may be obtained during the application process.

Additionally, a holographic fingerprint image 118 of the card holder's 108 fingerprint may be affixed to a back side of the payment card 102. The holographic fingerprint image 118 may work in conjunction with a fingerprint reader 200 (FIG. 2A). In some embodiments, the holographic fingerprint image 118 may be used by the merchant, including large corporations, to access identification and account information about the card holder 108. From the holographic fingerprint image 118, the merchant may store card holder 108 information directly rather than as alphanumeric codes. The holographic face and fingerprint images 116, 118 may also be efficacious for eliminating the need for magnetic or contoured identification components on the payment card 102.

FIG. 1 illustrates an example of yet another security feature employed by the system 100. A personal identification number (PIN) 114 is provided. The PIN 114 may be unique to the card holder 108, and shared between the card holder 108 and a card issuer 120, or financial institution. The PIN 114 may be used to authenticate the card holder 108 to the merchant. The PIN 114 does not have to be disclosed to the merchant by the card holder 108 at any point during the transaction. The PIN 114 can, however, be read by a point-of-sale card reader 300, through a swiping or scanning process. In some embodiments, the card holder 108 may have the authority to alter the PIN 114 at any time. In one embodiment, the PIN 114 is embedded into the payment card 102 as a magnetic code.

For additional security, the PIN 114 can be changed periodically by the card holder 108. Furthermore, the point-of-sale card reader 300 may automatically verify the PIN 114 without requiring the card holder 108 to enter the last four digits, as is commonly required. In another embodiment, the PIN 114 may be read completely by the point-of-sale card reader 300 through swiping or scanning. However, the card holder 108 may also enter the PIN 114 directly into the point-of-sale card reader 300.

In some embodiments, entry of the PIN 114 into the point-of-sale card reader 300 may provide verification that the payment card 102 is actually in the hand of the merchant. The PIN 114 may be automatically retrieved when a magnetic strip of a card is swiped on a point-of-sale card reader 300, and verified by a card issuer 120. However, should the payment card 102 by forged, one limitation is that the PIN 114 would still be valid.

Yet another security feature incorporated into the payment card 102 is the capacity to perform a decoy swipe with a decoy magnetic strip 122 on the payment card 102. The decoy swipe may enables a merchant or card holder 108 to pass the decoy magnetic strip 122 through a point-of-sale card reader 300 to give the impression that the payment card 102 utilizes a magnetic strip 122. The swiping motion may help create the impression the payment card 102 can be swiped. For example, an unauthorized user may think the payment card 102 is void if the decoy magnetic strip 122 does not trigger a transaction.

In one embodiment, the system 100 provides numerous security features prior to the transaction, such as when the payment card 102 is initially received by the card holder 108. The card issuer 120 may send the card holder 108 the payment card 102, and distribute a PIN 114 to the card holder 108, possibly through mail, email, text, or verbally in person. The holographic picture and fingerprint on the payment card 102 may have been provided during the application process for the payment card 102. The initial transaction performed by the card holder 108 may require entry of the PIN 114. The PIN 114 may be keyed in by the card holder 108 initially.

In another early form of security, the card holder 108 can set predetermined transaction parameters, such as spending limits, red flag alerts for certain transactions, and time usage parameters. The above mentioned security features may be combined on one payment card 102, and work in conjunction with a remote data storage site, such as a bank or a financial institute. However in other embodiments, multiple payment cards 102 may be used various combinations to achieve the desired security.

In some embodiments, an additional security feature may comprise the merchant processing the payment card 102 prior to completing the transaction to verify if sufficient funds are available for performing the transaction with the payment card 102. If funds are available, the transaction proceeds. Otherwise, the transaction is cancelled and an alert may be sent to the card holder 108 and/or the card issuer 120. The hidden card number 110 remains hidden from the merchant during this funds availability check, though.

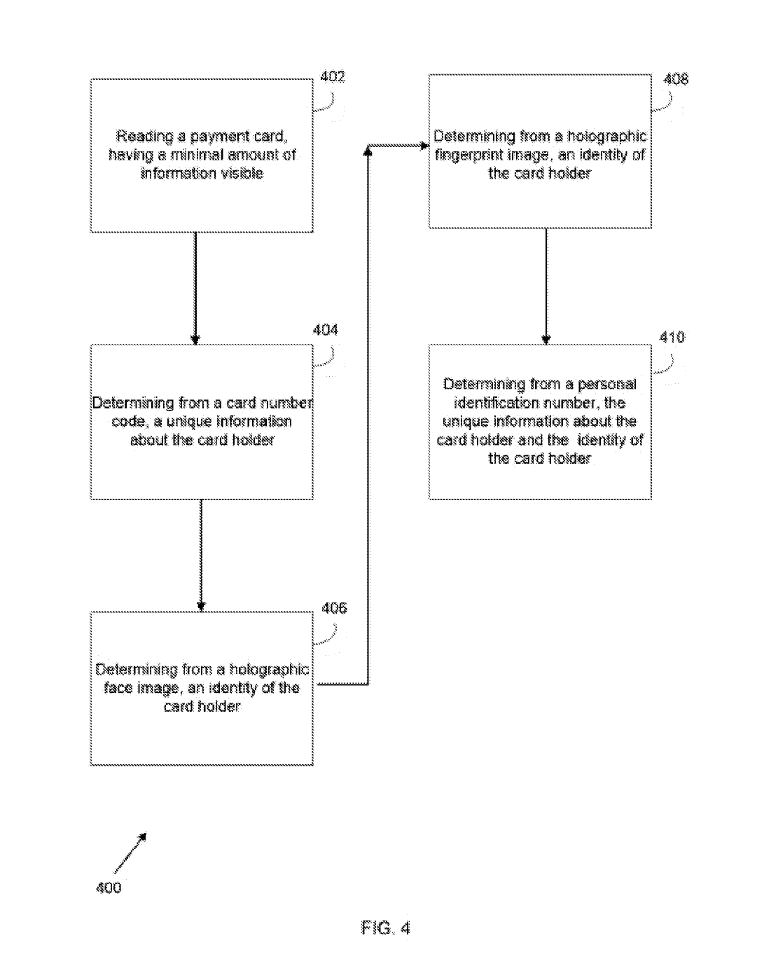

FIG. 4 illustrates a flowchart diagram of an exemplary security method 400 for a payment card 102. The method 400 may enable a card holder 108 and a card issuer 120 to protect against card fraud and identity theft through an eclectic number of security features. Each security feature, either working together or independently, helps to verify a card holder identity and provide unique card holder information. The method 400 may include an initial Step 402 of reading a payment card 102 having a minimal amount of information visible on a front surface 104 or a back surface 106. The payment card 102 is operatively connected to a hidden card number 110 that correlates to a card number code 112. The payment card 102 further comprises a holographic face image 116 and a holographic fingerprint image 118, both belonging to the card holder 108. The payment card 102 further operatively connects to the PIN 114, which is known only by the card holder 108, and altered at the will of the card holder 108.

The method 400 may further comprise a Step 404 of determining form the card number code 112, a unique information about the card holder 108. The card number code 112 correlates to the hidden card number 110. The card number code 112 provides information about the payment card 102, including, account information, address, and other verifying information. The card number code 112 may be stored with the card issuer 120, or a remote data storage site. A point-of-sale card reader 300 may read the card number code 112 during a transaction, yet not have the capacity to read or display the hidden card number 110. In this manner, the merchant cannot view the hidden card number 110. In some embodiments, by removing visible indications of the card number, unauthorized remote transactions may be restricted.

A Step 406 includes determining from the holographic face image 116, an identity of the card holder 108. The holographic face image 116 of the card holder 108 may print on a front side of the card to provide yet another layer of proof that the card holder 108 is actually the authorized user. The holographic face image 116 can quickly be compared to the card holder 108 for personal transactions.

In some embodiments, a Step 408 comprises determining from the holographic fingerprint image 118, the identity of the card holder 108. The card holder fingerprint can be obtained prior to receiving the payment card 102, such as during the application process. The holographic fingerprint image 118 may be affixed to a back side of the payment card 102. The holographic fingerprint image 118 may work in conjunction with a fingerprint reader 200, whereby a fingerprint reader 200 operatively connects to the remote data storage site for retrieving information about the card holder 108.

A final Step 410 includes determining from the PIN 114, the unique information about the card holder 108 and the identity of the card holder 108. The PIN 114 is selected and changed at will by the card holder 108. The PIN 114 may be required to enable the transaction. In some embodiments, the security method 400 is configured to deny a transaction with the payment card 102 based on failed verification of the unique information about the card holder 108 and the payment card 102 through the card number code 112, and/or the holographic face image 116, and/or the holographic fingerprint image 118, and/or the PIN 114.

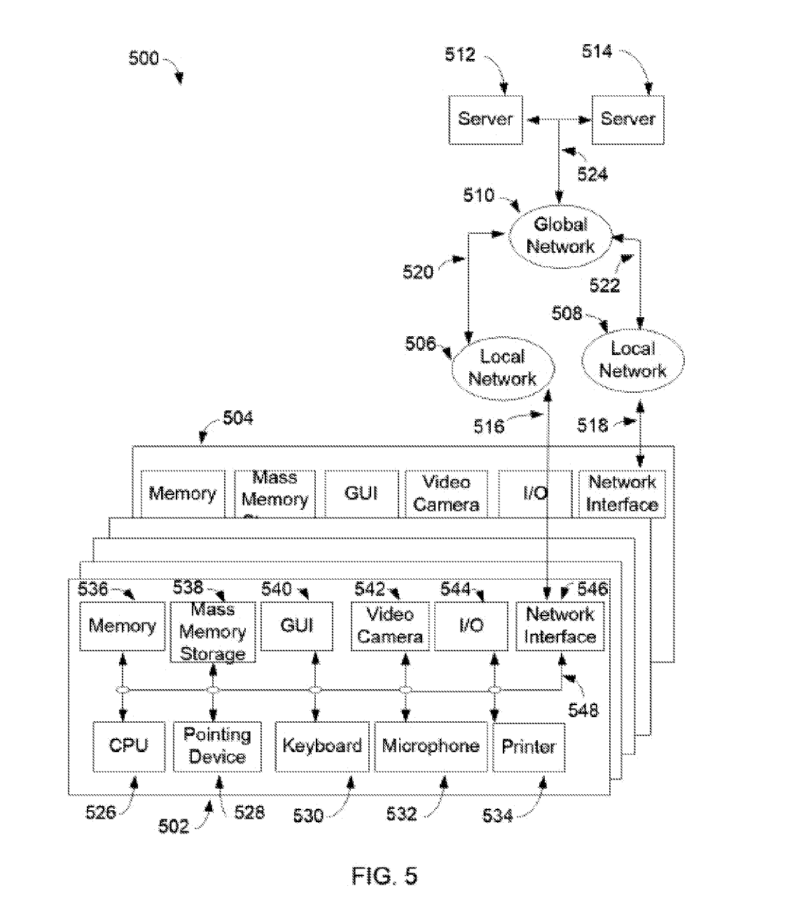

FIG. 5 illustrates a block diagram depicting an exemplary client/server system which may be used by an exemplary web-enabled/networked embodiment of the security system 100 and method 400 for a payment card. In the present invention, a communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A security system for preventing fraud and theft on a payment card, the security system comprising:
a payment card configured to help prevent payment card theft and identity fraud, the payment card comprising a minimal amount of information visible thereon,
the payment card comprising a hidden card number configured to identify the payment card and the card holder, the hidden card number arranged to remain at least partially invisible on the payment card, the hidden card number further configured to correlate to a card number code, the card number code configured to be different than the hidden card number, the card number code configured to verify a unique information about the card holder and the payment card for performing the transaction, the card number code further configured to form an indirect link to the unique information about the card holder and the payment card,
wherein a merchant views the card number code rather than the hidden card number for performing the transaction,
the payment card further comprising a holographic face image configured to replicate a card holder face, the holographic face image configured to verify the card holder for performing the transaction,
the payment card further comprising a holographic fingerprint image configured to replicate a card holder fingerprint, the holographic fingerprint image and the card holder fingerprint configured to be scannable by a fingerprint reader for verifying the card holder and performing the transaction,
the payment card further comprising a personal identification number configured to verify the card holder to the merchant, the personal identification number configured to be provided for enabling the transaction, the personal identification number further configured to be changed by the card holder,
wherein, only the card holder and/or the card issuer know the personal identification number,
wherein the security system is configured to deny the transaction based on failed verification of the unique information about the card holder and the payment card through the card number code, and/or the holographic face image, and/or the holographic fingerprint image, and/or the personal identification number.

2. The system of claim 1, in which the payment card comprises a credit card, a debit card, a charge card, or a gift certificate card.

3. The system of claim 1, in which the hidden card number comprises a card number and/or an expiration date, and/or a card verification number.

4. The system of claim 1, in which the hidden card number is configured to magnetically embed in the payment card and/or store in a remote data storage site.

5. The system of claim 1, in which the holographic face image is arranged on a front surface of the payment card.

6. The system of claim 1, in which the holographic fingerprint image is arranged on a back surface of the payment card.

7. The system of claim 1, in which the personal identification number is configured to magnetically embed in the payment card and/or store in a remote data storage site.

8. The system of claim 1, in which the point-of-sale reader and the fingerprint reader operatively connect to a remote data storage site, the remote data storage site comprising a unique information about the card holder and the payment card.

9. The system of claim 1, in which said merchant verifies if sufficient funds are available to perform said transaction by processing said payment card, said verification comprising said hidden card number remaining hidden to said merchant.

10. A security method for preventing fraud and theft on a payment card, the security method comprising:
reading a payment card having a minimal amount of information visible, the payment card operatively connected to a hidden card number that correlates to a card number code, the payment card comprising a holographic face image and a holographic fingerprint image, the payment card further operatively connected to a personal identification number;
determining form the card number code, a unique information about the card holder;
determining from the holographic face image, an identity of the card holder;
determining from the holographic fingerprint image, the identity of the card holder; and
determining from the personal identification number, the unique information about the card holder and the identity of the card holder,
wherein the security method is configured to deny a transaction with the payment card based on failed verification of the unique information about the card holder and the payment card through the card number code, and/or the holographic face image, and/or the holographic fingerprint image, and/or the personal identification number.

11. The method of claim 10, in which the payment card comprises a credit card, a debit card, a charge card, or a gift certificate card.

12. The method of claim 10, in which the hidden card number comprises a card number and/or an expiration date, and/or a card verification number.

13. The method of claim 10, in which the hidden card number is configured to magnetically embed in the payment card and/or store in a remote data storage site.

14. The method of claim 10, in which the holographic face image is arranged on a front surface of the payment card.

15. The method of claim 10, in which the holographic fingerprint image is arranged on a back surface of the payment card.

16. The method of claim 10, in which the personal identification number is configured to magnetically embed in the payment card and/or store in a remote data storage site.

17. A security system for preventing fraud and theft on a payment card, the security system consisting of:
a credit card configured perform a transaction, the credit card further configured to help prevent credit card theft and identity fraud, the credit card comprising a minimal amount of information visible thereon,
the credit card comprising a hidden card number configured to identify the credit card and the card holder, the hidden card number comprising a card number and/or an expiration date, and/or a card verification number, the hidden card number further configured to magnetically embed in the payment card, the hidden card number arranged to remain at least partially invisible on the credit card, the hidden card number further configured to correlate to a card number code, the card number code configured to be different than the hidden card number, the card number code configured to verify a unique information about the card holder and the credit card for performing the transaction, the card number code further configured to form an indirect link to the unique information about the card holder and the payment card,
wherein the merchant views the card number code rather than the hidden card number for performing the transaction,
the credit card further comprising a holographic face image configured to replicate a card holder face, the holographic face image configured to verify the card holder for performing the transaction, the holographic face image arranged on a front surface of the payment card,
the credit card further comprising a holographic fingerprint image configured to replicate a card holder fingerprint, the holographic fingerprint image and the card holder fingerprint configured to be scannable by a fingerprint reader for verifying the card holder and performing the transaction, the holographic fingerprint image arranged on a back surface of the payment card,
the credit card further comprising a personal identification number configured to verify the card holder to the merchant for enabling the transaction, the personal identification number further configured to be changed by the card holder,
wherein, only the card holder and/or the card issuer know the personal identification number,
wherein the security system is configured to deny the transaction based on failed verification of the unique information about the card holder and the credit card through the card number code, and/or the holographic face image, and/or the holographic fingerprint image, and/or the personal identification number.
